(19) United States
(12) Patent Application Publication
(10) Pub. No.: US 2021/0061291 A1
(43) Pub. Date: Mar. 4, 2021

(54) Inertial Sensor Unit, Electronic Apparatus, And Vehicle

(71) Applicant: Seiko Epson Corporation, Tokyo (JP)

(72) Inventor: Kazuyuki NAGATA, Minowa (JP)

(21) Appl. No.: 17/004,161

(22) Filed: Aug. 27, 2020

(30) Foreign Application Priority Data
Aug. 28, 2019 (JP) 2019-155527

(51) Int. Cl. B60W 40/107; G01P 15/08; G01P 3/44

(52) U.S. Cl. CPC B60W 40/107; B60W 2720/106; G01P 3/44; G01P 15/08

(57) ABSTRACT

An inertial sensor unit includes a first inertial sensor and a second inertial sensor. The first inertial sensor has a first acceleration sensor element configured to detect an acceleration in a direction along the first axis, and a second acceleration sensor element configured to detect an acceleration in a direction along the second axis. The second inertial sensor has a third acceleration sensor element configured to detect an acceleration in a direction along the third axis, and a fourth acceleration sensor element configured to detect an acceleration in a direction along the first axis. The first acceleration sensor element, the second acceleration sensor element, the third acceleration sensor element, and the fourth acceleration sensor element have comb-tooth shaped detection electrodes.

The present application is based on, and claims priority from JP Application Serial Number 2019-155527, filed Aug. 28, 2019, the disclosure of which is hereby incorporated by reference herein in its entirety.

### BACKGROUND

### 1. Technical Field

The present disclosure relates to an inertial sensor unit, an electronic apparatus, and a vehicle.

### 2. Related Art

Recently, an inertial sensor having a plurality of acceleration sensor elements and angular velocity sensor elements manufactured with the silicon MEMS (micro-electromechanical system) technology has been developed.

As such an inertial sensor, for example, JP-A-2018-173287 discloses a structure in which three acceleration sensor elements respectively detecting accelerations in directions along three axes, that is, an X-axis, a Y-axis, and a Z-axis, and three angular velocity sensor elements respectively detecting angular velocities about the three axes, that is, the X-axis, the Y-axis, and the Z-axis are provided on one chip. The acceleration sensor elements for the X-axis and the Y-axis and the angular velocity sensor element for the Z-axis has an in-plane detection electrode structure which detects a change in electrostatic capacitance between a moving part of the structure and a fixed part of the structure, that is, a structure in which each detection axis is along a main surface of the sensor element. Meanwhile, the acceleration sensor element for the Z-axis and the angular velocity sensor elements for the X-axis and the Y-axis have an out-of-plane detection electrode structure which detects a change in electrostatic capacitance between an electrode at the top of a substrate supporting the sensor element and the moving part of the structure, that is, a structure in which the detection axis intersects the main surface of the sensor element.

However, in the inertial sensor described in JP-A-2018-173287, the three acceleration sensor elements that can detects accelerations on the three axes and the three angular velocity sensor elements that can detect angular velocities about the three axes are formed on one chip. The sensor element having the in-plane detection electrode structure has a higher sensitivity particularly when the space between comb-tooth shaped detection electrodes is shorter. This requires narrow-gap processing. An etching condition with a high aspect ratio is preferable when processing the structure. Meanwhile, the sensor element having the out-of-plane detection electrode structure has a higher sensitivity when the courter electrode area in an out-of-plane direction is greater. Therefore, an etching condition with high redundancy such that the etching area differs depending on the site, for example, such that the detection electrode part of the structure has a small etching area whereas the other parts such as peripheries of a spring part have a large etching area, is preferable. Thus, the two etching conditions conflict with each other, posing a problem in that when the sensor element having the in-plane detection electrode structure and the sensor element having the out-of-plane detection electrode structure are installed together, the accuracy of processing the structure drops and therefore the sensitivity of detecting the acceleration and angular velocity deteriorates.

### SUMMARY

An inertial sensor unit includes: a substrate; a first inertial sensor arranged at the substrate, with a main surface of the first inertial sensor laid along a first axis and a second axis intersecting the first axis; and a second inertial sensor arranged at the substrate, with a main surface of the second inertial sensor laid along the first axis and a third axis intersecting the first axis and the second axis. The first inertial sensor has a first acceleration sensor element configured to detect an acceleration in a direction along the first axis, a second acceleration sensor element configured to detect an acceleration in a direction along the second axis, and a first angular velocity sensor element configured to detect an angular velocity about the third axis. The second inertial sensor has a third acceleration sensor element configured to detect an acceleration in a direction along the third axis, a fourth acceleration sensor element configured to detect an acceleration in a direction along the first axis, and a second angular velocity sensor element configured to detect an angular velocity about the second axis. The first acceleration sensor element, the second acceleration sensor element, and the first angular velocity sensor element have comb-tooth shaped detection electrodes. The third acceleration sensor element, the fourth acceleration sensor element, and the second angular velocity sensor element have comb-tooth shaped detection electrodes.

In the inertial sensor unit, a resonance frequency of a fundamental mode of the first acceleration sensor element and the second acceleration sensor element and an integral multiple of a drive frequency of the first angular velocity sensor element may be different from each other. A resonance frequency of a fundamental mode of the third acceleration sensor element and the fourth acceleration sensor element and an integral multiple of a drive frequency of the second angular velocity sensor element may be different from each other.

The inertial sensor unit may also have a third inertial sensor. The third inertial sensor may be arranged at the substrate, with a main surface of the third inertial sensor laid along the second axis and the third axis. The third inertial sensor may have a fifth acceleration sensor element configured to detect an acceleration in a direction along the second axis, a sixth acceleration sensor element configured to detect an acceleration in a direction along the third axis, and a third angular velocity sensor element configured to detect an angular velocity about the first axis. The fifth acceleration sensor element, the sixth acceleration sensor element, and the third angular velocity sensor element may have comb-tooth shaped detection electrodes.

In the inertial sensor unit, the first acceleration sensor element and the second acceleration sensor element may be arranged next to each other along the first axis. The first acceleration sensor element and the second acceleration sensor element, and the first angular velocity sensor element, may be arranged next to each other along the second axis. The third acceleration sensor element and the fourth acceleration sensor element may be arranged next to each other along the third axis. The third acceleration sensor element and the fourth acceleration sensor element, and the second angular velocity sensor element, may be arranged next to each other along the first axis. The fifth acceleration sensor element and the sixth acceleration sensor element may be arranged next to each other along the second axis. The fifth acceleration sensor element and the sixth acceleration sensor element, and the third angular velocity sensor element, may be arranged next to each other along the third axis.

In the inertial sensor unit, a resonance frequency of a fundamental mode of the fifth acceleration sensor element and the sixth acceleration sensor element and an integral multiple of a drive frequency of the third angular velocity sensor element may be different from each other.

An electronic apparatus includes the foregoing inertial sensor unit.

A vehicle includes the foregoing inertial sensor unit.

### BRIEF DESCRIPTION OF THE DRAWINGS

FIG. 1 is a perspective view showing a schematic configuration of an inertial sensor unit according to a first embodiment.

FIG. 2 is a plan view showing a schematic configuration of an inertial sensor.

FIG. 3 is a cross-sectional view taken along A-A in FIG. 2.

FIG. 4 is a plan view showing a schematic configuration of an acceleration sensor element.

FIG. 5 is a plan view showing a schematic configuration of an acceleration sensor element.

FIG. 6 is a plan view showing a schematic configuration of an angular velocity sensor element.

FIG. 7 is a block diagram showing a detection circuit of an acceleration sensor.

FIG. 8 is a perspective view showing a schematic configuration of an inertial sensor unit according to a second embodiment.

FIG. 9 is an exploded perspective view showing a schematic configuration of an inertial sensor unit according to a third embodiment.

FIG. 10 is a perspective view of a substrate shown in FIG. 9.

FIG. 11 is a perspective view showing the configuration of a mobile phone as an electronic apparatus having an inertial sensor unit according to a fourth embodiment.

FIG. 12 is a perspective view showing the configuration of an automobile as a vehicle having an inertial sensor unit according to a fifth embodiment.

### DESCRIPTION OF EXEMPLARY EMBODIMENTS

### 1. First Embodiment

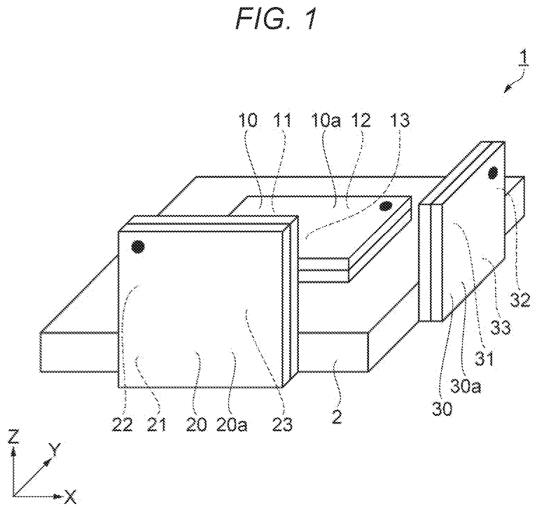

First, an inertial sensor unit 1 according to a first embodiment will be described with reference to FIGS. 1 to 6.

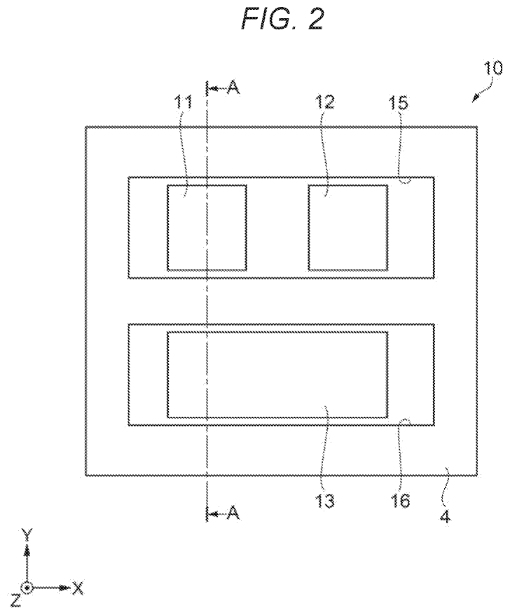

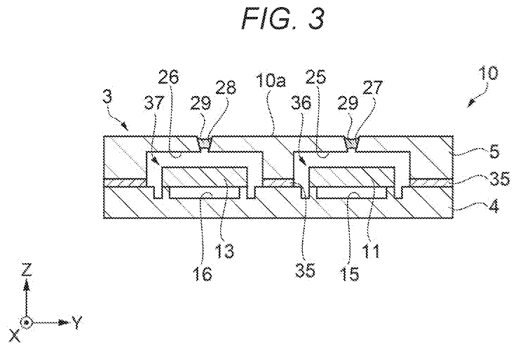

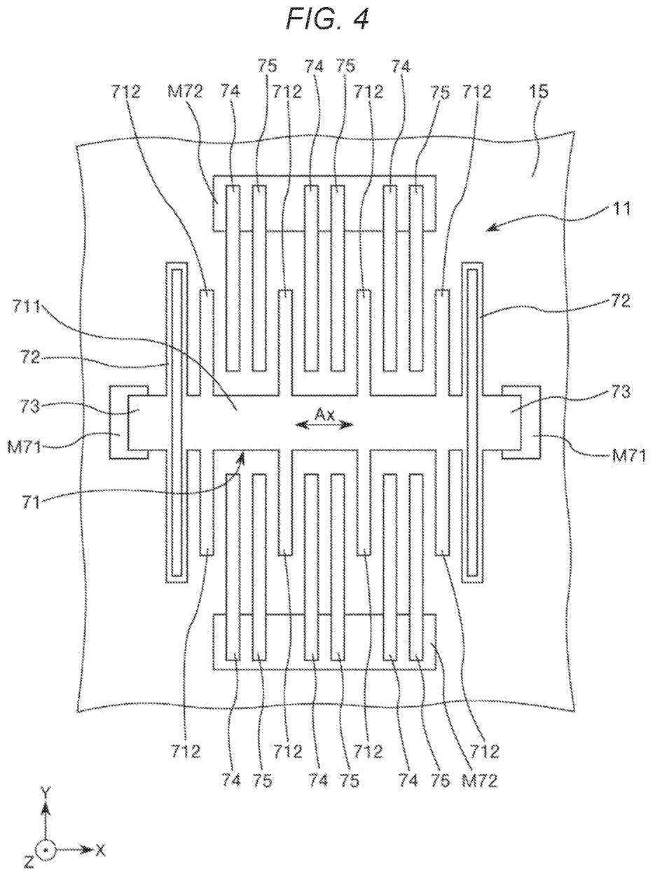

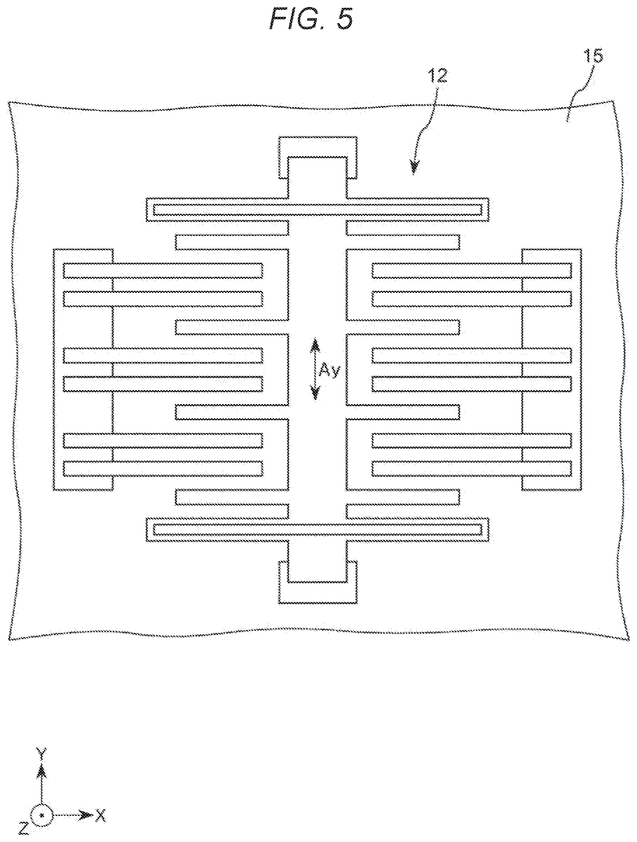

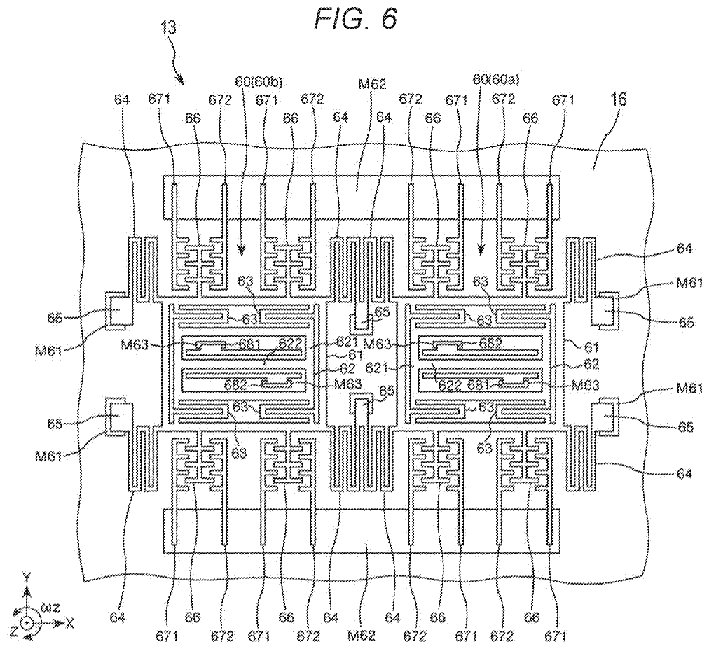

FIG. 1 is a perspective view showing a schematic configuration of the inertial sensor unit 1 according to the first embodiment. FIG. 2 is a plan view showing a schematic configuration of an inertial sensor 10. FIG. 3 is a cross-sectional view taken along A-A in FIG. 2. FIGS. 4 and 5 are plan views showing a schematic configuration of acceleration sensor elements 11, 12. FIG. 6 is a plan view showing a schematic configuration of an angular velocity sensor element 13. In FIG. 2, a lid 5 is not shown in order to make the illustration easy to understand. In each illustration, wirings, terminals and the like are not shown for the sake of convenience of the description, and the dimensional proportion of each component is different from reality in order to make the illustration easy to understand. An X-axis, a Y-axis, and a Z-axis in the illustrations are coordinate axes orthogonal to each other. A direction along the X-axis is referred to as an “X-direction”. A direction along the Y-axis is referred to as a “Y-direction”. A direction along the Z-axis is referred to as a “Z-direction”. The side indicated by an arrow is the positive side. In this embodiment, it is assumed that the X-axis is a first axis, the Y-axis is a second axis, and the Z-axis is a third axis.

The inertial sensor unit 1 shown in FIG. 1 is used as an inertial sensor configured to detect an acceleration and an angular velocity. Particularly, the inertial sensor unit 1 in this embodiment can separately detect an acceleration Ax in the X-direction, an acceleration Ay in the Y-direction, and an acceleration Az in the Z-direction, as accelerations, and can separately detect an angular velocity cox about the X-axis, an angular velocity ωy about the Y-axis, and an angular velocity ωz about the Z-axis, as angular velocities.

The inertial sensor unit 1 has a substrate 2, a first inertial sensor 10, a second inertial sensor 20, and a third inertial sensor 30.

The first inertial sensor 10 is arranged on an XY plane, which is a plane including the X-axis as the first axis and the Y-axis as the second axis, at an upper surface of the substrate 2, with a main surface 10a of the first inertial sensor 10 laid along the X-axis and the Y-axis.

The first inertial sensor 10 has, inside thereof, a first acceleration sensor element 11 configured to detect the acceleration Ax in the X-direction, a second acceleration sensor element 12 configured to detect the acceleration Ay in the Y-direction, and a first angular velocity sensor element 13 configured to detect the angular velocity ωz about the Z-axis.

The first acceleration sensor element 11 and the second acceleration sensor element 12 are arranged next to each other in the X-direction. The first acceleration sensor element 11 and the second acceleration sensor element 12, and the first angular velocity sensor element 13, are arranged next to each other in the Y-direction.

The second inertial sensor 20 is arranged on an XZ plane, which is a plane including the X-axis and the Z-axis as the third axis, at a lateral surface of the substrate 2, with a main surface 20a of the second inertial sensor 20 laid along the X-axis and the Z-axis.

The second inertial sensor 20 has, inside thereof, a third acceleration sensor element 21 configured to detect the acceleration Az in the Z-direction, a fourth acceleration sensor element 22 configured to detect the acceleration Ax in the X-direction, and a second angular velocity sensor element 23 configured to detect the angular velocity ωy about the Y-axis.

The third acceleration sensor element 21 and the fourth acceleration sensor element 22 are arranged next to each other in the Z-direction. The third acceleration sensor element 21 and the fourth acceleration sensor element 22, and the second angular velocity sensor element 23, are arranged next to each other in the X-direction.

The third inertial sensor 30 is arranged on a YZ plane, which is a plane including the Y-axis and the Z-axis, at a lateral surface of the substrate 2, with a main surface 30a of the third inertial sensor 30 laid along the Y-axis and the Z-axis.

The third inertial sensor 30 has, inside thereof, a fifth acceleration sensor element 31 configured to detect the acceleration Ay in the Y-direction, a sixth acceleration sensor element 32 configured to detect the acceleration Az in the Z-direction, and a third angular velocity sensor element 33 configured to detect the angular velocity ωx about the X-axis.

The fifth acceleration sensor element 31 and the sixth acceleration sensor element 32 are arranged next to each other in the Y-direction. The fifth acceleration sensor element 31 and the sixth acceleration sensor element 32, and the third angular velocity sensor element 33, are arranged next to each other in the Z-direction.

As shown in FIG. 1, in order to clarify the position of each internal sensor element, a black dot is provided near the positions where the second acceleration sensor element 12, the fourth acceleration sensor element 22, and the sixth acceleration sensor element 32 are arranged, in the first inertial sensor 10, the second inertial sensor 20, and the third inertial sensor 30.

The first inertial sensor 10 will now be described in detail.

As shown in FIGS. 2 and 3, the first inertial sensor 10 has the first acceleration sensor element 11, the second acceleration sensor element 12, the first angular velocity sensor element 13, and a package 3 accommodating the first acceleration sensor element 11, the second acceleration sensor element 12, and the first angular velocity sensor element 13.

The package 3 has a base 4 supporting each sensor element, and a lid 5 bonded to the base 4. A first accommodation section 36 accommodating the first acceleration sensor element 11 and the second acceleration sensor element 12, and a second accommodation section 37 accommodating the first angular velocity sensor element 13, are formed between the base 4 and the lid 5.

Each of the base 4 and the lid 5 is in the shape of a plate and arranged along an XY plane, which is a plane including the X-axis and the Y-axis.

The base 4 is provided with two recesses 15, 16 opening upward toward the lid 5. In the recess 15, a protrusion protruding from the bottom surface of the recess 15 is provided and supports the first acceleration sensor element 11 and the second acceleration sensor element 12. In the recess 16, a protrusion protruding from the bottom surface of the recess 16 is provided and supports the first angular velocity sensor element 13.

The lid 5 is provided with two recesses 25, 26 opening downward toward the base 4 at positions overlapping the recesses 15, 16. The lid 5 is provided over the base 4 in such a way as to contactlessly cover the first acceleration sensor element 11, the second acceleration sensor element 12, and the first angular velocity sensor element 13. The lower surface of the lid 5 excluding the recesses 25, 26 is bonded to the upper surface of the base 4 surrounding the recesses 15, 16 via a bonding member 35.

The recess 15 in the base 4 and the recess 25 in the lid 5 together form the first accommodation section 36 and accommodate the first acceleration sensor element 11 and the second acceleration sensor element 12. The recess 16 in the base 4 and the recess 26 in the lid 5 together form the second accommodation section 37 and accommodate the first angular velocity sensor element 13.

The first accommodation section 36 accommodating the first acceleration sensor element 11 and the second acceleration sensor element 12 is sealed, with an inert gas such as nitrogen, helium or argon included therein. At working temperatures of approximately −40° C. to 80° C., the pressure in the first accommodation section 36 is substantially equal to barometric pressures, for example, approximately 2.0×10⁴ to 2.0×10⁵ Pa. Thus, the sensitivity of detecting the acceleration can be improved. The first accommodation section 36 can be made airtight by closing a communication hole 27 provided above the recess 15, with a sealing member 29.

The second accommodation section 37 accommodating the first angular velocity sensor element 13 is in a state of reduced pressure, for example, approximately 1×10+² to 1×10⁻² Pa. Thus, the sensitivity of detecting the angular velocity can be improved. The second accommodation section 37 can be made airtight by closing a communication hole 28 provided above the recess 16, with the sealing member 29.

The respective sensor elements such as the first acceleration sensor element 11, the second acceleration sensor element 12, and the first angular velocity sensor element 13 are formed in one shot by etching to pattern a conductive silicon substrate doped with an impurity such as phosphorus or boron, for example, by dry etching such as reactive ion etching.

The material forming the base 4 is not particularly limited. However, an insulative material is preferable. Specifically, a high-resistivity silicon material or glass material is preferable. For example, a glass material containing a predetermined amount of alkali metal ions, for example, a borosilicate glass such as Pyrex (trademark registered) glass is preferable. Thus, when the respective sensor elements 11, 12, 13 contain silicon as a principal material, the base 4 and the respective sensor elements 11, 12, 13 can be anodically bonded together. Anodic bonding can firmly fix the respective sensor elements 11, 12, 13 to the base 4. Thus, a highly reliable inertial sensor 10 in which no separation occurs can be provided. Also, a quartz substrate, quartz crystal substrate, or SOI (silicon on insulator) substate may be used.

The material forming the lid 5 is not particularly limited. For example, a material similar to the base 4 can be used.

The method for bonding the base 4 and the lid 5 together differs depending on the materials forming the base 4 and the lid 5 and is not particularly limited. For example, a bonding method using a bonding material such as an adhesive, brazing material or glass frit material, or a solid bonding method such as direct bonding or anodic bonding can be used. Particularly when a glass frit material is used, the glass frit material flows out even on a rugged surface and thus can satisfactorily secure an airtight space. Particularly in the case of the first angular velocity sensor element 13, the second accommodation section 37 needs to be maintained in a state of reduced pressure and therefore a glass frit material can be suitably used.

The first acceleration sensor element 11, the second acceleration sensor element 12, and the first angular velocity sensor element 13 provided in the first inertial sensor 10 according to the first embodiment will now be described in detail.

First, the first acceleration sensor element 11 and the second acceleration sensor element 12 will be described.

The first acceleration sensor element 11 shown in FIG. 4 is a sensor element detecting the acceleration Ax in the X-direction. The first acceleration sensor element 11 has a moving part 71, a spring part 72, a fixed part 73, and fixed detection electrodes 74, 75.

The moving part 71 has a base part 711 extending in the X-direction and a plurality of moving detection electrodes 712 protruding to both sides of the Y-direction. Such a moving part 71 is coupled to the fixed part 73 via the spring part 72 at both ends of the base part 711. The fixed part 73 is fixed to a mount M71 protruding from the bottom surface of the recess 15. This makes the moving part 71 displaceable in the X-direction in relation to the fixed part 73. The fixed detection electrodes 74, 75 are fixed to a mount M72 protruding from the bottom surface of the recess 15. The moving detection electrode 712 is provided between the fixed detection electrodes 74, 75 and the fixed detection electrodes 74, 75. That is, the moving detection electrode 712 and the fixed detection electrodes 74, 75, as detection electrodes, are arranged interdigitally.

Although not illustrated, the base 4 is provided with a wiring electrically coupled to the moving part 71, a wiring electrically coupled to the fixed detection electrode 74, and a wiring electrically coupled to the fixed detection electrode 75. These wirings extend to the outside of the package 3. A predetermined voltage is applied to the moving part 71, the fixed detection electrode 74, and the fixed detection electrode 75 via the wirings, thus forming an electrostatic capacitance between the moving detection electrode 712 and each of the fixed detection electrodes 74, 75.

Such a first acceleration sensor element 11 can detect the acceleration Ax in the following manner. When the acceleration Ax is applied to the first acceleration sensor element 11, the moving part 71 is displaced in the X-direction while elastically deforming the spring part 72, based on the magnitude of the acceleration Ax. As the moving part 71 is displaced, the gap between the moving detection electrode 712 and the fixed detection electrode 74 and the gap between the moving detection electrode 712 and the fixed detection electrode 75 change and the electrostatic capacitance between these electrodes changes accordingly. Therefore, the first acceleration sensor element 11 can detect the acceleration Ax, based on the amount of change in the electrostatic capacitance.

The second acceleration sensor element 12 shown in FIG. 5 is a sensor detecting the acceleration Ay in the Y-direction. The second acceleration sensor element 12 is similar to the first acceleration sensor element 11 except for being rotated 90 degrees from the first acceleration sensor element 11. Therefore, the description of the second acceleration sensor element 12 is omitted.

The first accommodation section 36 accommodating such first acceleration sensor element 11 and second acceleration sensor element 12 is sealed, with an inert gas such as nitrogen, helium or argon included therein. At working temperatures of approximately −40° C. to 80° C., the pressure in the first accommodation section 36 is substantially equal to barometric pressures, for example, approximately 2.0×10⁴ to 2.0×10⁵ Pa. As barometric pressures are provided in the first accommodation section 36, viscous resistance increases and achieves a damping effect. Thus, the vibration of the moving part 71 of the first acceleration sensor element 11 and the second acceleration sensor element 12 can be swiftly resolved or stopped. This improves the sensitivity of detecting the accelerations Ax and Ay.

The first angular velocity sensor element 13 will now be described.

The first angular velocity sensor element 13 shown in FIG. 6 is a sensor detecting the angular velocity ωz about the Z-axis. The first angular velocity sensor element has two structures 60 (60a, 60b) arrayed in the X-direction. Each of the structures 60 (60a, 60b) has a vibrating part 61, a moving part 62, a detection spring part 63, a drive spring part 64, a fixed part 65, a moving drive electrode 66, fixed drive electrodes 671, 672, and fixed detection electrodes 681, 682. Such a structure 60 is formed in one shot by etching to pattern a conductive silicon substrate doped with an impurity such as phosphorus or boron.

The vibrating part 61 is a rectangular frame unit. The four corners of the vibrating part 61 are coupled to the fixed part 65 via the drive spring part 64. The fixed part 65 is fixed to a mount M61 protruding from the bottom surface of the recess 16. The moving drive electrode 66 is provided at the vibrating part 61. The fixed drive electrodes 671, 672 are fixed to a mount M62 protruding from the bottom surface of the recess 16. The moving drive electrode 66 is arranged between the fixed drive electrodes 671, 672.

The moving part 62 is arranged inside the vibrating part 61 and coupled to the vibrating part 61 via the detection spring part 63. The moving part 62 is displaceable in the Y-direction in relation to the vibrating part 61. The moving part 62 has a base part 621 and a moving detection electrode 622 provided at the base part 621 and extending in the X-direction. The fixed detection electrodes 681, 682 are fixed to a mount M63 protruding from the bottom surface of the recess 16. The moving detection electrode 622 is arranged between the fixed detection electrodes 681, 682. That is, the moving detection electrode 622 and the fixed detection electrodes 681, 682, as detection electrodes, are arranged interdigitally.

Although not illustrated, the base 4 is provided with a wiring electrically coupled to the moving detection electrode 622, a wiring electrically coupled to the fixed drive electrode 671, a wiring electrically coupled to the fixed drive electrode 672, a wiring electrically coupled to the fixed detection electrode 681, and a wiring electrically coupled to the fixed detection electrode 682. These wirings extend to the outside of the package 3. A predetermined voltage is applied to the moving detection electrode 622 and the fixed detection electrodes 681, 682 via the wirings, thus forming an electrostatic capacitance between the moving detection electrode 622 and each of the fixed detection electrodes 681, 682.

The first angular velocity sensor element 13 as described above can detect the angular velocity ωz in the following manner. First, a drive voltage is applied between the moving drive electrode 66 and the fixed drive electrodes 671, 672, thus causing the two vibrating parts 61 to vibrate in the opposite phases in the X-direction while elastically deforming the drive spring parts 64. When the angular velocity ωz is applied to the first angular velocity sensor element 13 in this state, a Coriolis force acts, causing the two moving parts 62 to vibrate in the opposite phases in the Y-direction while elastically deforming the detection spring parts 63. As the moving part 62 vibrates, the gap between the moving detection electrode 622 and the fixed detection electrode 681 and the gap between the moving detection electrode 622 and the fixed detection electrode 682 change and the electrostatic capacitance between these electrodes changes accordingly. Therefore, the first angular velocity sensor element 13 can detect the angular velocity ωz, based on the amount of change in the electrostatic capacitance.

The second accommodation section 37 accommodating such a first angular velocity sensor element 13 is in a state of reduced pressure, for example, approximately 1×10+² to 1×10⁻² Pa. Thus, viscous resistance decreases and can allow the vibrating part 61 in the first angular velocity sensor element 13 to vibrate efficiently and stably. This improves the sensitivity of detecting the angular velocity ωz.

The resonance frequency of the fundamental mode of the first acceleration sensor element 11 and the second acceleration sensor element 12 is designed to be different from an integral multiple of the drive frequency of the first angular velocity sensor element 13. Therefore, the resonance of the first acceleration sensor element 11 and the second acceleration sensor element 12 due to the drive vibration of the first angular velocity sensor element 13 can be avoided and noises due to the resonance of the first acceleration sensor element 11 and the second acceleration sensor element 12 can be reduced.

The first inertial sensor 10 has been described. The second inertial sensor 20 and the third inertial sensor have a configuration similar to that of the first inertial sensor 10, except for having the X-axis, the Y-axis, and the Z-axis in different directions. The third acceleration sensor element 21 or the fifth acceleration sensor element 31 is arranged at the position of the first acceleration sensor element 11. The fourth acceleration sensor element 22 or the sixth acceleration sensor element 32 is arranged at the position of the second acceleration sensor element 12. The second angular velocity sensor element 23 or the third angular velocity sensor element 33 is arranged at the position of the first angular velocity sensor element 13.

In the second inertial sensor 20, the resonance frequency of the fundamental mode of the third acceleration sensor element 21 and the fourth acceleration sensor element 22 is designed to be different from an integral multiple of the drive frequency of the second angular velocity sensor element 23. In the third inertial sensor 30, the resonance frequency of the fundamental mode of the fifth acceleration sensor element 31 and the sixth acceleration sensor element 32 is designed to be different from an integral multiple of the drive frequency of the third angular velocity sensor element 33.

In the inertial sensor unit 1 according to this embodiment, two acceleration sensor elements and one angular velocity sensor element having comb-tooth shaped detection electrodes are formed on one chip. Therefore, all the elements can be processed under an etching condition with a high aspect ratio and comb-tooth shaped detection electrodes with a short space between the electrodes can be easily formed. Thus, the inertial sensors 10, 20, 30 that can detect an acceleration and an angular velocity with high sensitivity can be provided. Since the three inertial sensors 10, 20, 30, each having two acceleration sensor elements and one angular velocity sensor element, are arranged at the substrate 2, two acceleration sensor elements detect an acceleration on one axis. Therefore, noises against the acceleration can be reduced and the acceleration can be detected more accurately.

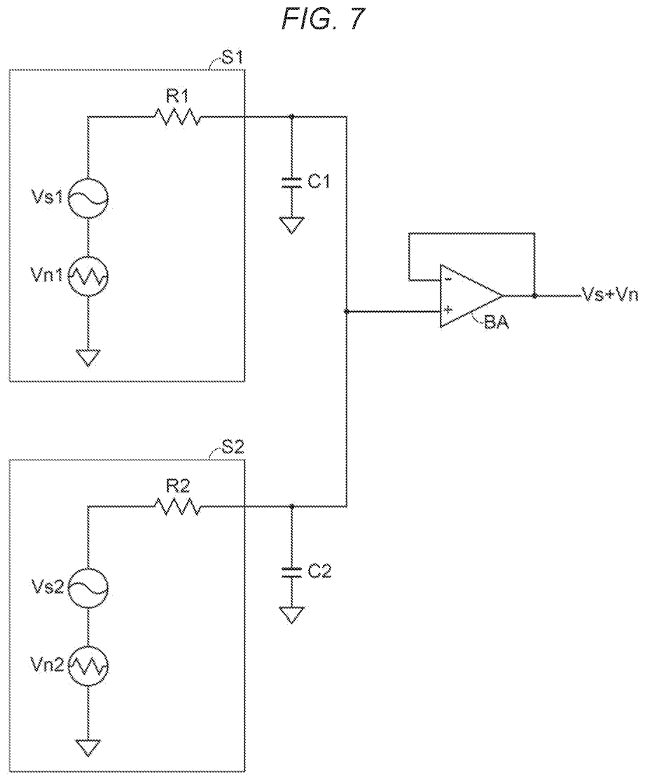

Noise reduction by two acceleration sensor elements S1, S2 will now be described with reference to FIG. 7.

FIG. 7 is a block diagram showing a detection circuit of an acceleration sensor.

As shown in FIG. 7, an acceleration detected by the two acceleration sensor elements S1, S2 becomes an output from a buffer amplifier BA, that is, Vs+Vn, which is the sum of an acceleration signal output Vs and a sensor noise output Vn.

Based on the principle of superposition, the instantaneous value Vs of the acceleration signal component from the buffer amplifier BA is expressed by the following equation (1).

Vs=1/2Vs1+1/2VS2 (1)

In the equation (1), Vs1 is the instantaneous value of the acceleration signal component from the acceleration sensor element S1 and Vs2 is the instantaneous value of the acceleration signal component from the acceleration sensor element S2. Here, Vs1 and Vs2 from the acceleration sensor elements S1, S2 are acceleration components in the same direction. Therefore, Vs1=Vs2. This leads to Vs=Vs1=Vs2. When the effective values of Vs1 and Vs2 are expressed as Es1 and Es2, the effective value Es of Vs is Es=Es1=Es2.

Meanwhile, the instantaneous value Vn of the sensor noise component of the output from the buffer amplifier BA is expressed by the following equation (2), similarly to the acceleration signal component.

Vn=1/2Vn1+1/2Vn2 (2)

In the equation (2), Vn1 is the instantaneous value of the sensor noise component from the acceleration sensor element S1 and Vn2 is the instantaneous value of the sensor noise component from the acceleration sensor element S2. When the effective values of the noise outputs Vn1 and Vn2 are expressed as En1 and En2, the effective value En of Vn is calculated according to the following equation (3) of root mean square (RMS).

En=\sqrt{(1/2En1)²+(1/2En2)²}=1/2\sqrt{(En1)²+(En2)²} (3).

Here, Vn1 and Vn2 are random noises of the acceleration sensor elements S1, S2 having the same characteristic. Therefore, En1=En2, leading to the following equation (4).

$$En = \frac{1}{\sqrt{2}} En 1 = \frac{1}{\sqrt{2}} En 2 \qquad ( 4 )$$

From the above result, the S/N ratio is expressed by the following equation (5).

$$\frac{Es}{En} = \sqrt{2} \frac{Es 1}{En 1} = \sqrt{2} \frac{Es 2}{En 2} \qquad ( 5 )$$

Thus, the S/N ratio is improved to 1.41 times by parallel coupling of two acceleration sensor elements, compared with the case of using one acceleration sensor element. That is, the noises of the two acceleration sensor outputs are different from each other and random, unlike the signal components.

The inertial sensor unit 1 according to this embodiment is configured to detect the accelerations Ax, Ay, Az on the three axes of the X-axis, the Y-axis, and the Z-axis, and the angular velocities ωx, ωy, ωz about the three axes of the X-axis, the Y-axis, and the Z-axis, using three inertial sensors. However, the inertial sensor unit may be configured to detect accelerations on two axes and angular velocities about two axes, using two inertial sensors.

A described above, in the inertial sensor unit 1 according to this embodiment, each of the first acceleration sensor element 11, the second acceleration sensor element 12, the third acceleration sensor element 21, the fourth acceleration sensor element 22, the fifth acceleration sensor element 31, the sixth acceleration sensor element 32, the first angular velocity sensor element 13, the second angular velocity sensor element 23, and the third angular velocity sensor element 33 has comb-tooth shaped detection electrodes. Therefore, all the elements can be processed under an etching condition with a high aspect ratio and comb-tooth shaped detection electrodes with a short space between the electrodes can be easily formed. Thus, an acceleration and an angular velocity can be detected with high sensitivity. Also, since two acceleration sensor elements detect an acceleration on one axis, noises against the acceleration can be reduced and the acceleration can be detected more accurately.

### 2. Second Embodiment

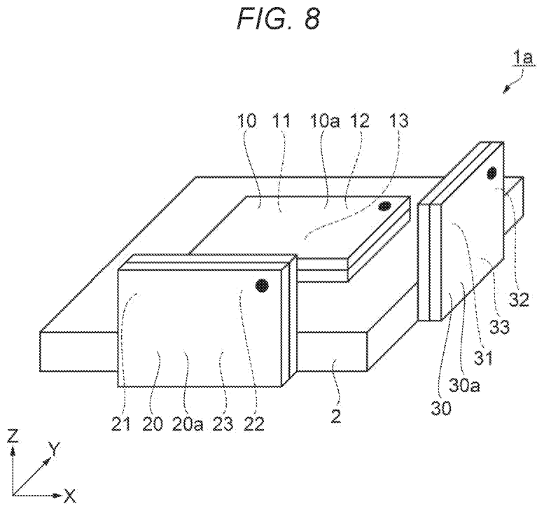

An inertial sensor unit 1a according to a second embodiment will now be described with reference to FIG. 8.

FIG. 8 is a perspective view showing a schematic configuration of the inertial sensor unit 1a according to the second embodiment.

The inertial sensor unit 1a according to this embodiment detects accelerations Ax, Ay, Az in directions along three axes and angular velocities ωx, ωy, ωz about three axes, and can detect an acceleration on one axis by two acceleration sensor elements, similarly to the inertial sensor unit 1 according to the first embodiment. The inertial sensor unit 1a is similar to the inertial sensor unit 1 according to the first embodiment, except that the arrangement of the second inertial sensor 20 is different from that in the inertial sensor unit 1 according to the first embodiment. This embodiment is described mainly in terms of the difference from the first embodiment. The description of similar matters is omitted.

In the inertial sensor unit 1a, the second inertial sensor 20 in the first embodiment is rotated 90 degrees clockwise and thus arranged on the XZ plane of the substrate 2 so that, inside the second inertial sensor 20, the third acceleration sensor element 21 and the fourth acceleration sensor element 22 of the second inertial sensor 20 are arranged next to each other in the X-direction and the third acceleration sensor element 21 and the fourth acceleration sensor element 22, and the second angular velocity sensor element 23, of the second inertial sensor 20, are arranged next to each other in the Z-direction, as shown in FIG. 8.

In such a configuration, the first acceleration sensor element 11 of the first inertial sensor 10 and the third acceleration sensor element 21 of the second inertial sensor 20 detect the acceleration Ax in the X-direction, and the fourth acceleration sensor element 22 of the second inertial sensor 20 and the sixth acceleration sensor element 32 of the third inertial sensor 30 detect the acceleration Az in the Z-direction. Thus, at the time of forming a chip, the first acceleration sensor element 11 and the third acceleration sensor element 21 are formed as patterns in which the longitudinal direction of the moving part 71 is the same. Therefore, the first acceleration sensor element 11 and the third acceleration sensor element 21 have the same level of manufacturing variation and also receive the same level of influence of noise. Based on the principle of superposition, the S/N ratio of these sensor elements can be increased. Similarly, the fourth acceleration sensor element 22 and the sixth acceleration sensor element 32 are formed as the same patterns. Therefore, the S/N ratio of these sensor elements can be increased. This enables the provision of the inertial sensor unit 1a that can detect an acceleration more accurately.

### 3. Third Embodiment

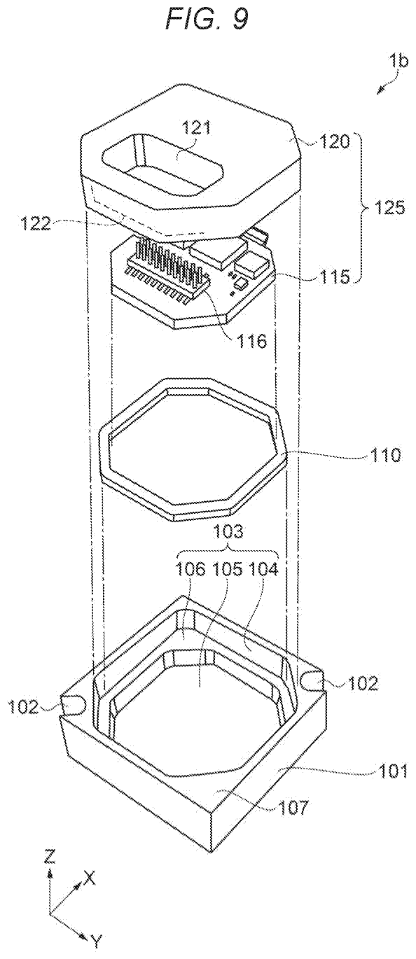

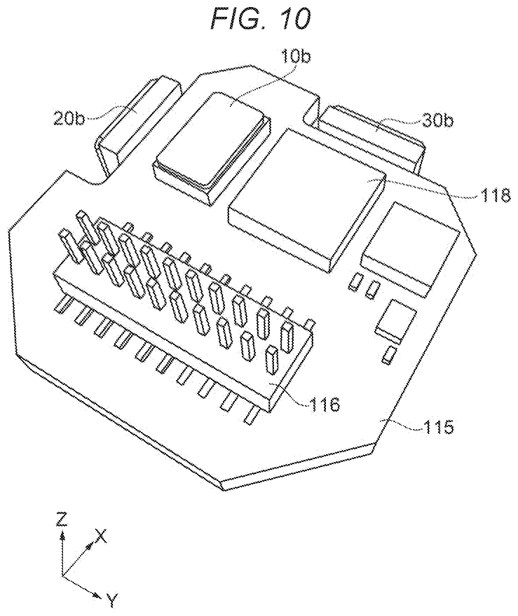

An inertial sensor unit 1b according to a third embodiment will now be described with reference to FIGS. 9 and 10.

FIG. 9 is an exploded perspective view showing a schematic configuration of the inertial sensor unit 1b according to the third embodiment. FIG. 10 is a perspective view of a substrate 115 in FIG. 9.

The inertial sensor unit 1b according to this embodiment detects accelerations Ax, Ay, Az in directions along three axes and angular velocities ωx, ωy, ωz about three axes, and can detect an acceleration on one axis by two acceleration sensor elements, similarly to the inertial sensor unit 1 according to the first embodiment. The inertial sensor unit 1b is similar to the inertial sensor unit 1 according to the first embodiment, except that three inertial sensors 10b, 20b, 30b arranged at the substrate 115 are provided as a sensor module 125 and packaged by an outer case 101 and an inner case 120.

The inertial sensor unit 1b is an inertial measurement unit (IMU) detecting an amount of inertial motion such as an attitude or behavior of a moving body such as an automobile or robot. The inertial sensor unit 1b has the sensor module 125 having a substrate 115, a first inertial sensor 10b, a second inertial sensor 20b, and a third inertial sensor 30b, and functions as a so-called six-axis motion sensor having acceleration sensor elements for three axes and angular velocity sensor elements for three axes. Each of the inertial sensors 10b, 20b, 30b has two acceleration sensor elements and one angular velocity sensor element, similarly to the inertial sensors 10, 20, 30 in the first embodiment. The inertial sensor unit 1b can be miniaturized, for example, into a size that can be installed in a mobile phone or smartphone, by selecting components and changing designs.

As shown in FIG. 9, the inertial sensor unit 1b is formed of the outer case 101, a bonding member 110, and the sensor module 125 or the like. The sensor module 125 is formed of the inner case 120 and the substrate 115.

The outer case 101 is a pedestal of aluminum sliced out into the shape of a box. The outer shape of the outer case 101 is a rectangular parallelepiped having a substantially square planar shape. A cut-out hole 102 is formed near each of two vertices located on a diagonal line of the square. With a screw inserted into the cut-out hole 102, the inertial sensor unit 1b can be used in the state of being fixed to an installation target surface of an installation target object such as an automobile.

The outer case 101 is in the shape of a box having a rectangular-parallelepiped outer shape and having no lid. An interior 103 of the outer case 101 is a space surrounded by a bottom wall 105 and a sidewall 104. The planar shape of the interior 103 is a heptagon formed by chamfering the corners of three vertices of the square. Two of the three chamfered vertices correspond to the positions of the cut-out holes 102. As viewed in a cross-section of the interior 103, a first bonding surface 106 that is one step higher than the bottom wall 105 is formed between the bottom wall 105 and the sidewall 104. The first bonding surface 106 is a part of the sidewall 104 and a ring-shaped one-step site surrounding the bottom wall 105 as viewed in a plan view.

The inner case 120 is a member supporting the substrate 115 and is shaped to be fit in the interior 103 of the outer case 101. Specifically, as viewed in a plan view, the inner case 120 is a heptagon formed by chamfering the corners of three vertices of the square. An opening 121, which is a rectangular penetration hole, is formed in the inner case 120. Two of the three chamfered vertices correspond to the positions of the cut-out holes 102 in the outer case 101. In the Z-direction, the inner case 120 is lower than the height from an upper surface 107 to the first bonding surface 106 of the outer case 101.

At a surface of the inner case 120 facing the outer case 101, which is the back surface of the inner case 120, a pin and a support surface, not illustrated, for positioning the substrate 115, are formed. The substrate 115 is set by the guide pin and the support surface and thus installed at the back surface of the inner case 120. A peripheral edge of the back surface of the inner case 120 is a second bonding surface 122, which is a ring-shaped planar surface. The second bonding surface 122 is shaped substantially similarly to the first bonding surface 106 of the outer case 101 as viewed in a plan view. When the inner case 120 is set in the outer case 101, the two bonding surfaces face each other via the bonding member 110.

The substrate 115 is a multilayer substrate having a plurality of through-holes formed therein. A glass epoxy substrate or the like is used as the substrate 115.

At a surface of the substrate 115 facing the inner case 120, which is the face side of the substrate 115, a connector 116, the first inertial sensor 10b, and a control IC 118 or the like are installed, as shown in FIG. 10. The second inertial sensor 20b and the third inertial sensor 30b are installed at lateral surfaces of the substrate 115.

The connector 116 is a plug-type connector and has two lines of coupling terminals arranged at an equal pitch in the X-direction. A socket-type connector, not illustrated, is coupled to the connector 116 from an installation target device. Electric power of the inertial sensor unit 1b and electrical signals such as detection data are transmitted and received between these connectors.

The first inertial sensor 10b is installed on an XY plane, which is a plane including the X-axis and the Y-axis, at the upper surface of the substrate 115, with a main surface of the first inertial sensor 10b laid along the X-axis and the Y-axis.

The first inertial sensor 10b can detect the acceleration Ax in the X-direction and the acceleration Ay in the Y-direction and can detect the angular velocity ωz about the Z-axis.

The second inertial sensor 20b is installed on an XZ plane, which is a plane including the X-axis and the Z-axis, at a lateral surface of the substrate 115, with a main surface of the second inertial sensor 20b laid along the X-axis and the Z-axis.

The second inertial sensor 20b can detect the acceleration Ax in the X-direction and the acceleration Az in the Z-direction and can detect the angular velocity ωy about the Y-axis.

The third inertial sensor 30b is installed on an YZ plane, which is a plane including the Y-axis and the Z-axis, at a lateral surface of the substrate 115, with a main surface of the third inertial sensor 30b laid along the Y-axis and the Z-axis.

The third inertial sensor 30b can detect the acceleration Ay in the Y-direction and the acceleration Az in the Z-direction and can detect the angular velocity ωx about the X-axis.

The control IC 118 is a micro controller unit (MCU) and has a storage unit including a non-volatile memory, and an A/D converter or the like, as built-in components. The control IC 118 controls each part of the inertial sensor unit 1b. In the storage unit, a program prescribing an order and content of detecting an acceleration and an angular velocity, a program for digitizing and incorporating detection data into package data, accompanying data and the like are stored. Also, a plurality of other electronic components are installed at the substrate 115.

As described above, the inertial sensor unit 1b according to this embodiment can achieve the following effects.

The inertial sensor unit 1b has the outer case 101 with the cut-out hole 102 formed therein. Therefore, when the inertial sensor unit 1b is used in the state of being fixed to an installation target surface of an installation target object such as an automobile with a screw inserted in the cut-out hole 102, the inertial sensor unit 1b can serve as an inertial measurement unit (IMU) detecting an amount of inertial motion such as an attitude or behavior the automobile.

Since the three inertial sensors 10b, 20b, 30b, each having two acceleration sensor elements and one angular velocity sensor element, are arranged at the substrate 115, two acceleration sensor elements detect an acceleration on one axis. Therefore, noises against the acceleration can be reduced and the acceleration can be detected more accurately.

### 4. Fourth Embodiment

A mobile phone 1200 will now be described as an example of an electronic apparatus having any one of the inertial sensor units 1, 1a, 1b, according to a fourth embodiment. In the description below, a configuration employing the inertial sensor unit 1 will be described.

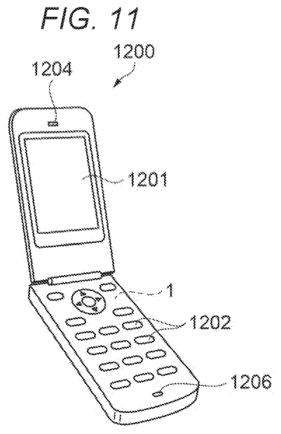

FIG. 11 is a perspective view showing the configuration of the mobile phone 1200 having the inertial sensor unit 1.

As shown in FIG. 11, the mobile phone 1200 has a plurality of operation buttons 1202, a receiver port 1204, and a transmitter port 1206. A display unit 1201 is arranged between the operation buttons 1202 and the receiver port 1204.

The inertial sensor unit 1 is built in such a mobile phone 1200.

Such an electronic apparatus has the inertial sensor unit 1 and therefore achieves the effects described in the embodiments and excellent performance.

The electronic apparatus having any one of the inertial sensors 1, 1a, 1b can be applied not only to the mobile phone 1200 but also to other devices, for example, an inkjet ejection device such as inkjet printer, laptop or mobile personal computer, television, digital still camera, video camera, video tape recorder, various navigation devices, pager, electronic organizer including one with communication function, electronic dictionary, electronic calculator, electronic game device, word processor, workstation, videophone, security monitor, electronic binoculars, POS terminal, fishfinder, various measuring devices, various instruments, flight simulator, and medical equipment such as electronic body thermometer, blood pressure monitor, blood sugar monitor, electrocardiograph, ultrasonic diagnostic device, or electronic endoscope. In any case, these electronic apparatuses have any one of the inertial sensor units 1, 1a, 1b and therefore achieve the effects described in the embodiments and excellent performance.

### 5. Fifth Embodiment

An automobile 1500 will now be described as an example of a vehicle having any one of the inertial sensor units 1, 1a, 1b, according to a fifth embodiment. In the description below, a configuration employing the inertial sensor unit 1b will be described.

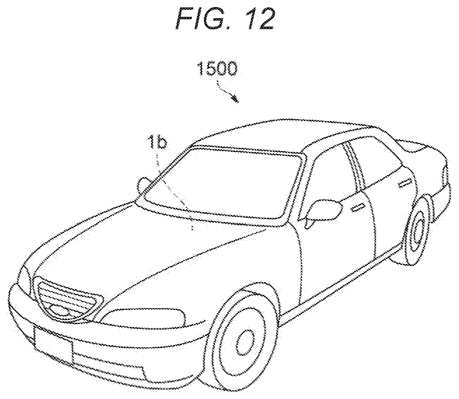

FIG. 12 is a perspective view showing the automobile 1500 having the inertial sensor unit 1b.

As shown in FIG. 12, the automobile 1500 uses the inertial sensor unit 1b, for example, as an attitude detection sensor in a navigation device, attitude control device or the like installed in the automobile 1500.

According to this configuration, the automobile 1500 has the inertial sensor unit 1b and therefore achieves the effects described in the embodiments and excellent performance.

The inertial sensor units 1, 1a, 1b can be used suitably as an attitude detection sensor not only in the automobile 1500 but also in other vehicles including self-propelled robot, self-propelled transport device, train, ship, airplane, artificial satellite, and the like. In any case, a vehicle that achieves the effects described in the embodiments and excellent performance can be provided.

The contents derived from the embodiments will now be described.

An inertial sensor unit includes: a substrate; a first inertial sensor arranged at the substrate, with a main surface of the first inertial sensor laid along a first axis and a second axis intersecting the first axis; and a second inertial sensor arranged at the substrate, with a main surface of the second inertial sensor laid along the first axis and a third axis intersecting the first axis and the second axis. The first inertial sensor has a first acceleration sensor element configured to detect an acceleration in a direction along the first axis, a second acceleration sensor element configured to detect an acceleration in a direction along the second axis, and a first angular velocity sensor element configured to detect an angular velocity about the third axis. The second inertial sensor has a third acceleration sensor element configured to detect an acceleration in a direction along the third axis, a fourth acceleration sensor element configured to detect an acceleration in a direction along the first axis, and a second angular velocity sensor element configured to detect an angular velocity about the second axis. The first acceleration sensor element, the second acceleration sensor element, and the first angular velocity sensor element have comb-tooth shaped detection electrodes. The third acceleration sensor element, the fourth acceleration sensor element, and the second angular velocity sensor element have comb-tooth shaped detection electrodes.

In this configuration, each of the first acceleration sensor element, the second acceleration sensor element, the third acceleration sensor element, the fourth acceleration sensor element, the first angular velocity sensor element, and the second angular velocity sensor element has comb-tooth shaped detection electrodes. Therefore, all the elements can be processed under an etching condition with a high aspect ratio and comb-tooth shaped detection electrodes with a short space between the electrodes can be easily formed. Thus, an inertial sensor unit that can detect an acceleration and an angular velocity with high sensitivity can be provided. Also, since two acceleration sensor elements detect an acceleration on one axis, noises against the acceleration can be reduced and the acceleration can be detected more accurately.

In the inertial sensor unit, a resonance frequency of a fundamental mode of the first acceleration sensor element and the second acceleration sensor element and an integral multiple of a drive frequency of the first angular velocity sensor element may be different from each other. A resonance frequency of a fundamental mode of the third acceleration sensor element and the fourth acceleration sensor element and an integral multiple of a drive frequency of the second angular velocity sensor element may be different from each other.

In this configuration, the resonance frequency of the fundamental mode of the acceleration sensor elements and an integral multiple of the drive frequency of the angular velocity sensor element are different from each other. Therefore, the resonance of the acceleration sensor elements due to the drive vibration of the angular velocity sensor element can be avoided and noises due to the resonance of the acceleration sensor elements can be reduced.

The inertial sensor unit may also have a third inertial sensor. The third inertial sensor may be arranged at the substrate, with a main surface of the third inertial sensor laid along the second axis and the third axis. The third inertial sensor may have a fifth acceleration sensor element configured to detect an acceleration in a direction along the second axis, a sixth acceleration sensor element configured to detect an acceleration in a direction along the third axis, and a third angular velocity sensor element configured to detect an angular velocity about the first axis. The fifth acceleration sensor element, the sixth acceleration sensor element, and the third angular velocity sensor element may have comb-tooth shaped detection electrodes.

In this configuration, each of the fifth acceleration sensor element, the sixth acceleration sensor element, and the third angular velocity sensor element has comb-tooth shaped detection electrodes. Therefore, all the elements can be processed under an etching condition with a high aspect ratio and comb-tooth shaped detection electrodes with a short space between the electrodes can be easily formed. Thus, an inertial sensor unit that can detect accelerations in the directions along three axes of the first axis, the second axis, and the third axis, and angular velocities about the three axes of the first axis, the second axis, and the third axis with high sensitivity, can be provided.

In the inertial sensor unit, the first acceleration sensor element and the second acceleration sensor element may be arranged next to each other along the first axis. The first acceleration sensor element and the second acceleration sensor element, and the first angular velocity sensor element, may be arranged next to each other along the second axis. The third acceleration sensor element and the fourth acceleration sensor element may be arranged next to each other along the third axis. The third acceleration sensor element and the fourth acceleration sensor element, and the second angular velocity sensor element, may be arranged next to each other along the first axis. The fifth acceleration sensor element and the sixth acceleration sensor element may be arranged next to each other along the second axis. The fifth acceleration sensor element and the sixth acceleration sensor element, and the third angular velocity sensor element, may be arranged next to each other along the third axis.

In this configuration, the first acceleration sensor element and the fourth acceleration sensor element can detect an acceleration in the direction along the first axis. The second acceleration sensor element and the fifth acceleration sensor element can detect an acceleration in the direction along the second axis. The third acceleration sensor element and the sixth acceleration sensor element can detect an acceleration in the direction along the third axis. Since two acceleration sensor elements detect an acceleration on one axis, noises against the acceleration can be reduced. Thus, an inertial sensor unit that can detect an acceleration with high accuracy can be provided.

In the inertial sensor unit, a resonance frequency of a fundamental mode of the fifth acceleration sensor element and the sixth acceleration sensor element and an integral multiple of a drive frequency of the third angular velocity sensor element may be different from each other.

In this configuration, the resonance frequency of the fundamental mode of the acceleration sensor elements and an integral multiple of the drive frequency of the angular velocity sensor element are different from each other. Therefore, the resonance of the acceleration sensor elements due to the drive vibration of the angular velocity sensor element can be avoided and noises due to the resonance of the acceleration sensor elements can be reduced.

An electronic apparatus includes the foregoing inertial sensor unit.

According to this configuration, an electronic apparatus that has a high-accuracy inertial sensor unit and therefore achieves high performance can be provided.

A vehicle includes the foregoing inertial sensor unit.

According to this configuration, a vehicle that has a high-accuracy inertial sensor unit and therefore achieves high performance can be provided.

What is claimed is:

1. An inertial sensor unit comprising:
a substrate;
a first inertial sensor arranged at the substrate, with a main surface of the first inertial sensor laid along a first axis and a second axis intersecting the first axis; and
a second inertial sensor arranged at the substrate, with a main surface of the second inertial sensor laid along the first axis and a third axis intersecting the first axis and the second axis,
the first inertial sensor having a first acceleration sensor element configured to detect an acceleration in a direction along the first axis, a second acceleration sensor element configured to detect an acceleration in a direction along the second axis, and a first angular velocity sensor element configured to detect an angular velocity about the third axis,
the second inertial sensor having a third acceleration sensor element configured to detect an acceleration in a direction along the third axis, a fourth acceleration sensor element configured to detect an acceleration in a direction along the first axis, and a second angular velocity sensor element configured to detect an angular velocity about the second axis,
the first acceleration sensor element, the second acceleration sensor element, and the first angular velocity sensor element having comb-tooth shaped detection electrodes,
the third acceleration sensor element, the fourth acceleration sensor element, and the second angular velocity sensor element having comb-tooth shaped detection electrodes.

2. The inertial sensor unit according to claim 1, wherein
a resonance frequency of a fundamental mode of the first acceleration sensor element and the second acceleration sensor element and an integral multiple of a drive frequency of the first angular velocity sensor element are different from each other, and
a resonance frequency of a fundamental mode of the third acceleration sensor element and the fourth acceleration sensor element and an integral multiple of a drive frequency of the second angular velocity sensor element are different from each other.

3. The inertial sensor unit according to claim 1, further comprising
a third inertial sensor, wherein
the third inertial sensor is arranged at the substrate, with a main surface of the third inertial sensor laid along the second axis and the third axis,
the third inertial sensor has a fifth acceleration sensor element configured to detect an acceleration in a direction along the second axis, a sixth acceleration sensor element configured to detect an acceleration in a direction along the third axis, and a third angular velocity sensor element configured to detect an angular velocity about the first axis, and
the fifth acceleration sensor element, the sixth acceleration sensor element, and the third angular velocity sensor element have comb-tooth shaped detection electrodes.

4. The inertial sensor unit according to claim 3, wherein
the first acceleration sensor element is arranged next to the second acceleration sensor element along the first axis,
the first angular velocity sensor element is arranged next to the first acceleration sensor element and the second acceleration sensor element along the second axis,
the third acceleration sensor element is arranged next to the fourth acceleration sensor element along the third axis,
the second angular velocity sensor element is arranged next to the third acceleration sensor element and the fourth acceleration sensor element along the first axis,
the fifth acceleration sensor element is arranged next to the sixth acceleration sensor element along the second axis, and
the third angular velocity sensor element is arranged next to the fifth acceleration sensor element and the sixth acceleration sensor element along the third axis.

5. The inertial sensor unit according to claim 3, wherein
a resonance frequency of a fundamental mode of the fifth acceleration sensor element and the sixth acceleration sensor element and an integral multiple of a drive frequency of the third angular velocity sensor element are different from each other.

6. An inertial sensor unit comprising:
a substrate;
a first inertial sensor arranged at the substrate, with a main surface of the first inertial sensor laid along a first axis and a second axis intersecting the first axis; and
a second inertial sensor arranged at the substrate, with a main surface of the second inertial sensor laid along the first axis and a third axis intersecting the first axis and the second axis,
the first inertial sensor having a first acceleration sensor element configured to detect an acceleration in a direction along the first axis, and a second acceleration sensor element configured to detect an acceleration in a direction along the second axis,
the second inertial sensor having a third acceleration sensor element configured to detect an acceleration in a direction along the third axis, and a fourth acceleration sensor element configured to detect an acceleration in a direction along the first axis,
the first acceleration sensor element, the second acceleration sensor element, the third acceleration sensor element, and the fourth acceleration sensor element having comb-tooth shaped detection electrodes.

7. The inertial sensor unit according to claim 6, further comprising
a third inertial sensor, wherein
the third inertial sensor is arranged at the substrate, with a main surface of the third inertial sensor laid along the second axis and the third axis,
the third inertial sensor has a fifth acceleration sensor element configured to detect an acceleration in a direction along the second axis, and a sixth acceleration sensor element configured to detect an acceleration in a direction along the third axis, and
the fifth acceleration sensor element and the sixth acceleration sensor element have comb-tooth shaped detection electrodes.

8. The inertial sensor unit according to claim 7, wherein
the first acceleration sensor element is arranged next to the second acceleration sensor element along the first axis,
the third acceleration sensor element is arranged next to the fourth acceleration sensor element along the third axis, and
the fifth acceleration sensor element is arranged next to the sixth acceleration sensor element along the second axis.

9. An inertial sensor unit comprising:
a substrate;
a first inertial sensor arranged at the substrate, with a main surface of the first inertial sensor laid along a first axis and a second axis intersecting the first axis; and
a second inertial sensor arranged at the substrate, with a main surface of the second inertial sensor laid along the first axis and a third axis intersecting the first axis and the second axis,
the first inertial sensor having a first acceleration sensor element configured to detect an acceleration in a direction along the first axis, a second acceleration sensor element configured to detect an acceleration in a direction along the second axis, and a first angular velocity sensor element configured to detect an angular velocity about the third axis,
the second inertial sensor having a third acceleration sensor element configured to detect an acceleration in a direction along the third axis, a fourth acceleration sensor element configured to detect an acceleration in a direction along the first axis, and a second angular velocity sensor element configured to detect an angular velocity about the second axis,
each of the first acceleration sensor element, the second acceleration sensor element, and the first angular velocity sensor element having a first detection electrode and a second detection electrode,
the first detection electrode and the second detection electrode extending in a certain direction,
one of the first detection electrode and the second detection electrode being a fixed detection electrode,
the other of the first detection electrode and the second detection electrode being a moving detection electrode,
each of the third acceleration sensor element, the fourth acceleration sensor element, and the second angular velocity sensor element having a third detection electrode and a fourth detection electrode,
the third detection electrode and the fourth detection electrode extending in a certain direction,
one of the third detection electrode and the fourth detection electrode being a fixed detection electrode,
the other of the third detection electrode and the fourth detection electrode being a moving detection electrode.

10. The inertial sensor unit according to claim 9, wherein
some or all of the first acceleration sensor element, the second acceleration sensor element, and the first angular velocity sensor element have a fifth detection electrode,
the second detection electrode are arranged between the first detection electrode and the fifth detection electrode,
some or all of the third acceleration sensor element, the fourth acceleration sensor element, and the second angular velocity sensor element have a sixth detection electrode,
the fourth detection electrode are arranged between the third detection electrode and the sixth detection electrode.

11. The inertial sensor unit according to claim 9, further comprising
a third inertial sensor, wherein
the third inertial sensor is arranged at the substrate, with a main surface of the third inertial sensor laid along the second axis and the third axis,
the third inertial sensor has a fifth acceleration sensor element configured to detect an acceleration in a direction along the second axis, a sixth acceleration sensor element configured to detect an acceleration in a direction along the third axis, and a third angular velocity sensor element configured to detect an angular velocity about the first axis,
each of the fifth acceleration sensor element, the sixth acceleration sensor element, and the third angular velocity sensor element having a seventh detection electrode and an eighth detection electrode,
the seventh detection electrode and the eighth detection electrode extending in a certain direction,
one of the seventh detection electrode and the eighth detection electrode being a fixed detection electrode,
the other of the seventh detection electrode and the eighth detection electrode being a moving detection electrode,

12. An electronic apparatus comprising the inertial sensor unit according to claim 1.

13. An electronic apparatus comprising the inertial sensor unit according to claim 6.

14. An electronic apparatus comprising the inertial sensor unit according to claim 9.

15. A vehicle comprising the inertial sensor unit according to claim 1.

16. A vehicle comprising the inertial sensor unit according to claim 6.

17. A vehicle comprising the inertial sensor unit according to claim 9.
